(19) United States
(12) Patent Application Publication
(10) Pub. No.: US 2026/0242919 A1
(43) Pub. Date: Aug. 20, 2026

(54) HOT-DIP COATED STEEL SHEET, FRAME, AND METHOD FOR MANUFACTURING HOT-DIP COATED STEEL SHEET

(71) Applicant: NIPPON STEEL CORPORATION, Tokyo (JP)

(72) Inventor: Toyomitsu NAKAMURA, Tokyo (JP)

(73) Assignee: NIPPON STEEL CORPORATION, Tokyo (JP)

(21) Appl. No.: 19/164,338

(22) PCT Filed: Mar. 28, 2024
(86) PCT No.: PCT/JP2024/012894

§ 371 Date: Sep. 11, 2025

(30) Foreign Application Priority Data
Mar. 30, 2023 (JP) 2023-055729

(51) Int. Cl. C23C 2/06; C22C 18/04; C22C 38/00; C22C 38/02; C22C 38/04; C22C 38/06; C23C 2/02

(52) U.S. Cl. CPC C23C 2/06; C22C 18/04; C22C 38/002; C22C 38/02; C22C 38/04; C22C 38/06; C23C 2/022

(57) ABSTRACT

This hot-dip coated steel sheet includes a steel sheet and a coated layer provided on the steel sheet, wherein the steel sheet has a predetermined first chemical composition, the tensile strength of the steel sheet is 740 MPa or more, the area fraction of SiO₂ is less than 0.4% in a region from the surface of the steel sheet up to 3 μm in the sheet thickness direction, the coated layer has a predetermined second chemical composition, the coated layer includes an Al—Fe-based interface alloy layer in contact with the surface of the steel sheet, and the Al—Fe-based interface alloy layer has a thickness of 1.0-3.0 μm.

### TECHNICAL FIELD

The present invention relates to a hot-dip coated steel sheet, a frame, and a method for manufacturing a hot-dip coated steel sheet.

The present application claims priority based on Japanese Patent Application No. 2023-055729, filed Mar. 30, 2023, the content of which is incorporated herein by reference.

### BACKGROUND ART

A steel sheet on the surface of which a hot-dip Zn-coated layer containing Al and Mg is formed (a hot-dip Zn—Al—Mg-based coated steel sheet) has exceptional corrosion resistance. Accordingly, hot-dip Zn—Al—Mg-based coated steel sheets are widely used, for example, as a material for structural members required to have corrosion resistance, such as building materials.

For example, Patent Document 1 discloses an Si-containing high strength hot-dip galvanized steel sheet having good coating adhesion and corrosion resistance after coating, in which a steel layer having an internal oxide content of SiO₂ of 0.4-2.0 mass % is formed as a first layer on the surface of a high strength steel sheet having an Si content of 0.4-2.0 mass % to have a thickness of 3 μm or less, on which a hot-dip galvanized layer composed of Al: 0.2-10 mass % and the balance of Zn and unavoidable impurities is formed.

### CITATION LIST

### Patent Document

Patent Document 1: Japanese Unexamined Patent Application, First Publication No. 2001-323355

### SUMMARY OF INVENTION

### Technical Problem

In hot-dip Zn—Al—Mg-based coated steel sheets, higher strengthening is required. However, since the high strength steel sheet has a high content of Si and low coating wettability, when coating is performed by a normal method, there are problems in that coating is not formed, the external appearance is deteriorated, and coating is peeled off during processing. For example, in the technique of Patent Document 1, since coating is performed using a continuous hot-dip coating device having an oxidation zone, Si, Mn, and Fe on the surface layer can be oxidized together in the oxidation zone, and only Fe can be reduced in a reduction zone. As a result, the coating wettability can be improved, but there is a problem in that an oxide of Si is formed on the surface layer of the steel sheet, the carbon concentration in the surface layer of the steel sheet decreases, and the surface layer of the steel sheet is altered.

The present invention has been made in view of the above problems, and an object of the present invention is to provide a hot-dip coated steel sheet, a frame, and a method for manufacturing a hot-dip coated steel sheet which are exceptional in formability and external appearance and in which formation of SiO₂ oxide is suppressed.

### Solution to Problem

In order to solve the above problems, the present invention proposes the means described below.
<1> A hot-dip coated steel sheet of aspect 1 of the present invention includes
a steel sheet, and
a coated layer provided on the steel sheet,
wherein
a first chemical composition that is a chemical composition of the steel sheet contains, by mass %,
C: 0.05%-0.20%,
Mn: 1.00%-3.00%,
Si: 0.40%-2.00%,
P: 0.001%-0.100%,
S: 0.0001%-0.0100%, and
Al: 0.001%-1.500%,
a balance includes Fe and impurities,
a tensile strength of the steel sheet is 740 MPa or more, and
in a region from a surface of the steel sheet up to 3 μm in a sheet thickness direction,
an area fraction of SiO₂ is less than 0.4%, and
a second chemical composition that is a chemical composition of the coated layer contains, by mass %,
Al: 10%-13%,
Mg: 3%-5%, and
Si: 0.5% or less,
a balance includes Zn and impurities,
the coated layer includes an Al—Fe-based interface alloy layer in contact with the surface of the steel sheet, and
a thickness of the Al—Fe-based interface alloy layer is 1.0-3.0 μm.
<2> According to aspect 2 of the present invention, in the hot-dip coated steel sheet of aspect 1, the first chemical composition may further contain, by mass %, one or two or more selected from the group consisting of
Ti: 0.001%-0.150%,
Nb: 0.001%-0.100%, and
V: 0.001%-0.300%.
<3> According to aspect 3 of the present invention, in the hot-dip coated steel sheet of aspect 1 or 2, the first chemical composition may further contain, by mass %, one or two or more selected from the group consisting of
Cr: 0.01%-2.00%,
Ni: 0.01%-2.00%,
Cu: 0.01%-2.00%,
Mo: 0.01%-2.00%,
B: 0.0001%-0.0100%, and
W: 0.01%-2.00%.
<4> According to aspect 4 of the present invention, in the hot-dip coated steel sheet of any one of aspects 1-3, the area fraction of SiO₂ may be 0.1% or more.
<5> According to aspect 5 of the present invention, in the hot-dip coated steel sheet of any one of aspects 1-4, the first chemical composition may further contain, by mass %,
one or two or more of Ca, Mg, Zr, and REM in a total amount of 0.0001%-0.0100%.
<6> A method for manufacturing a hot-dip coated steel sheet of a sixth aspect of the present invention, including a continuous coating step of coating a base steel sheet having a first chemical composition using a continuous hot-dip galvanizing line with all-radiant tube heating system, wherein
in the continuous coating step,
reduction annealing is performed on the base steel sheet in an atmosphere of 2-10 vol % of hydrogen and 0.002 vol %-0.05 vol % of water vapor under a reduction condition of a maximum temperature of a surface temperature of the base steel sheet of 775° C. or more and a retention time at 750° C. or more of 30 seconds or more,
the base steel sheet after the reduction annealing is immersed in a coating bath at
a coating bath temperature of 470° C.-520° C. and an entry material temperature of 470° C.-520° C., or
a coating bath temperature of 450° C. to less than 470° C. and an entry material temperature of 490° C.-520° C.
for 3 seconds or more,
the first chemical composition contains, by mass %,
C: 0.05%-0.20%,
Mn: 1.00%-3.00%,
Si: 0.40%-2.00%,
P: 0.001%-0.100%,
S: 0.0001%-0.0100%, and
Al: 0.001%-1.500%,
a balance includes Fe and impurities,
a chemical composition of the coating bath contains, by mass %,
Al: 10%-13%,
Mg: 3%-5%, and
Si: 0.5% or less, and
a balance includes Zn and impurities.
<7> A frame according to aspect 7 of the present invention uses the hot-dip coated steel sheet according to aspect 1.

### Advantageous Effects of Invention

According to the above aspects of the present invention, it is possible to provide a hot-dip coated steel sheet, a frame, and a method for manufacturing a hot-dip coated steel sheet which are exceptional in formability and external appearance and in which formation of SiO₂ oxide is suppressed.

### DESCRIPTION OF EMBODIMENTS

The present inventors have extensively conducted studies on a hot-dip coated steel sheet which is exceptional in formability and external appearance and in which formation of SiO₂ oxide is suppressed and resultantly found that formation of an oxide of Si can be suppressed in the surface layer of the steel sheet using a continuous hot-dip galvanizing line with all-radiant tube heating system having no oxidation zone. Furthermore, the present inventors have found that a hot-dip coated steel sheet exceptional in formability and external appearance can be obtained by performing coating on the steel sheet in which formation of an oxide of Si on the surface layer is suppressed while controlling the temperature of a coating bath and the temperature of the steel sheet entering the coating bath within a predetermined range, and have completed the present invention. In the present specification, the formability of a hot-dip coated steel sheet refers to adhesion between the steel sheet and the coated layer at a folded portion of the hot-dip coated steel sheet, which is evaluated after the hot-dip coated steel sheet is folded. The external appearance refers to the coverage of the coated layer.

Hereinafter, a hot-dip coated steel sheet according to an embodiment of the present invention will be described. A hot-dip coated steel sheet according to the present embodiment includes a steel sheet and a coated layer provided on the steel sheet, wherein a first chemical composition that is the chemical composition of the steel sheet contains, by mass %, C: 0.05%-0.20%, Mn: 1.00%-3.00%, Si: 0.40%-2.00%, P: 0.001%-0.100%, S: 0.0001-0.0100%, and Al: 0.001-1.500%, and the balance is composed of Fe and impurities, the tensile strength of the steel sheet is 740 MPa or more, the area fraction of SiO₂ is less than 0.4% in a region from the surface of the steel sheet up to 3 μm in the sheet thickness direction, a second chemical composition that is the chemical composition of the coated layer contains, by mass %, Al: 10%-13%, Mg: 3%-5%, and Si: 0.5% or less, and the balance is composed of Zn and impurities, the coated layer includes an Al—Fe-based interface alloy layer in contact with the surface of the steel sheet, and the thickness of the Al—Fe-based interface alloy layer is 1.0-3.0 μm.

In the following description, the expression “%” of the content of each element in the chemical composition means “mass %”. The content of an element in the chemical composition may be referred to as an element concentration (for example, Zn concentration, Mg concentration, and the like). In the present specification, the “coated layer” means a coated film manufactured by the so-called hot-dip galvanizing.

### (Steel Sheet)

A first chemical composition that is the chemical composition of the steel sheet contains, by mass %, C: 0.05%-0.20%, Mn: 1.00%-3.00%, Si: 0.40%-2.00%, P: 0.001%-0.100%, S: 0.0001%-0.0100%, and Al: 0.001%-1.500%, with the balance being composed of Fe and impurities. Hereinafter, each element will be described.

### [C: 0.05%-0.20%]

Cis an element added to increase the strength of the steel sheet. However, when the C content exceeds 0.20%, the weldability is deteriorated, and thus the C content is 0.20% or less. From the viewpoint of weldability, the C content is preferably 0.15% or less. On the other hand, when the C content is less than 0.05%, the strength decreases, and it becomes difficult to secure sufficient tensile strength, and thus the C content is 0.05% or more. In order to further increase the strength, the C content is preferably 0.06% or more, more preferably 0.07% or more.

### [Mn: 1.00%-3.00%]

Mn is added to increase the strength by increasing the hardenability of the steel sheet. However, when the Mn content exceeds 3.00%, a coarse Mn concentrated portion is generated at the center portion of the sheet thickness of the steel sheet, so that embrittlement easily occurs, and troubles such as cracking of a cast slab easily occur. Accordingly, the Mn content is 3.00% or less. In addition, when the Mn content increases, the weldability also deteriorates. For this reason, the Mn content is preferably 2.80% or less, more preferably 2.70% or less. On the other hand, when the Mn content is less than 1.00%, a large amount of soft microstructure is formed during cooling after annealing, so that it becomes difficult to secure sufficiently high tensile strength. Accordingly, the Mn content is 1.00% or more. In order to further increase the strength, the Mn content is preferably 1.20% or more, more preferably 1.40% or more.

### [Si: 0.40%-2.00%]

Si is an element that suppresses generation of an iron-based carbide in the steel sheet and enhances the strength and formability. However, Si is also an element that embrittles the steel sheet, and when the content of Si exceeds 2.00%, issues such as cracking of a cast slab easily occur. Accordingly, the Si content is 2.00% or less. Furthermore, Si forms an oxide on the surface of the base steel sheet in the annealing step, and thus significantly impairs the adhesion of coating. From this viewpoint, the Si content is preferably 1.90% or less, more preferably 1.60% or less. On the other hand, when the Si content is less than 0.40%, a large amount of coarse iron-based carbide is generated in the step of coating a hot-dip coated steel sheet, and thus the strength and formability are deteriorated. Accordingly, the Si content is 0.40% or more. From the viewpoint of suppressing generation of an iron-based carbide, the Si content is preferably 0.50% or more, more preferably 0.60% or more.

### [P: 0.001%-0.100%]

P is an element that embrittles the steel sheet, and when the P content exceeds 0.100%, troubles such as cracking of a cast slab easily occur. Accordingly, the P content is 0.100% or less. In addition, P is also an element that embrittles a molten portion generated by spot welding, and in order to obtain sufficient weld joint strength, the P content is preferably 0.040% or less, more preferably 0.020% or less. On the other hand, adjusting the P content to less than 0.001% involves a significant increase in manufacturing cost. Accordingly, the P content is 0.001% or more, preferably 0.010% or more.

### [S: 0.0001%-0.0100%]

S is an element that combines with Mn to form coarse MnS and deteriorates the formability, Accordingly, the S content is 0.0100% or less, In addition, S is also an element that deteriorates the spot weldability. Accordingly, the S content is preferably 0.0060% or less, more preferably 0.0035% or less. On the other hand, adjusting the S content to less than 0.0001% involves a significant increase in manufacturing cost. Accordingly, the S content is 0.0001% or more, preferably 0.0005% or more, more preferably 0.0010% or more.

### [Al: 0.001%-1.500%]

Al is an element that embrittles the steel sheet. When the Al content exceeds 1.500%, troubles such as cracking of a cast slab easily occur, and thus the Al content is 1.500% or less. In addition, the weldability deteriorates when the Al content increases. Accordingly, the Al content is preferably 1.200% or less, more preferably 1.000% or less.

Al is an impurity present in a trace amount in the raw material and adjusting the content of Al to less than 0.001% involves a significant increase in manufacturing cost, so that the Al content is 0.001% or more. In addition, Al is an element effective as a deoxidizing material. In order to more sufficiently obtain a deoxidizing effect, the Al content is preferably 0.010% or more.

The steel sheet according to the present embodiment contains the above elements, and the balance may be of Fe and impurities. Here, the impurities are elements that are mixed via raw materials such as ore and scrap, and various factors in the manufacturing step when the steel is industrially manufactured and are elements that are allowed to exist as long as the characteristics of the steel sheet according to the present embodiment are not impaired. In addition, an element that is not a component intentionally added to the steel sheet is also included.

Furthermore, to the steel sheet of the hot-dip coated steel sheet according to the embodiment of the present invention, the following elements may be added as necessary. Specifically, in addition to the above chemical components, one or two or more selected from Ti: 0.001%-0.150%, Nb: 0.001%-0.100%, and V: 0.001%-0.300% may be contained. These elements may not be contained, and thus the lower limit of the content of each of these elements is 0%.

### [Ti: 0.001%-0.150%]

Ti is an element that contributes to an increase in strength of the steel sheet by precipitate strengthening, fine grain strengthening through suppression of the growth of ferrite grains, and dislocation strengthening through suppression of recrystallization. However, when the Ti content exceeds 0.150%, the precipitation of carbonitrides increases and the formability deteriorates, and thus the Ti content is preferably 0.150% or less. From the viewpoint of formability, the Ti content is more preferably 0.080% or less. In order to sufficiently obtain a strength-increasing effect by Ti addition, the Ti content is preferably 0.001% or more, In order to further increase high-strengthening of the steel sheet, the Ti content is more preferably 0.010% or more.

### [Nb: 0.001%-0.100%]

Nb is an element that contributes to an increase in strength of the steel sheet by precipitate strengthening, fine grain strengthening through suppression of the growth of ferrite grains, and dislocation strengthening through suppression of recrystallization. However, when the Nb content exceeds 0.100%, the precipitation of carbonitrides increases and the formability deteriorates, and thus the Nb content is more preferably 0.100% or less. From the viewpoint of formability, the Nb content is more preferably 0.060% or less. In order to sufficiently obtain a strength-increasing effect by Nb addition, the Nb content is preferably 0.001% or more. In order to further increase high-strengthening of the steel sheet, the Nb content is more preferably 0.005% or more.

### [V: 0.001%-0.300%]

V is an element that contributes to an increase in strength of the steel sheet by precipitate strengthening, fine grain strengthening through suppression of the growth of ferrite grains, and dislocation strengthening through suppression of recrystallization. However, when the V content exceeds 0.300%, carbonitride deposition increases, so that the formability is deteriorated. Accordingly, the V content is preferably 0.300% or less, more preferably 0.200% or less. In order to sufficiently obtain a strength-increasing effect by V addition, the V content is preferably 0.001% or more, more preferably 0.010% or more.

The steel sheet according to the present embodiment may further contain one or two or more selected from Cr: 0.01%-2.00%, Ni: 0.01%-2.00%, Cu: 0.01%-2.00%, Mo: 0.01%-2.00%, B: 0.0001%-0.0100%, and W: 0.01% to 2.00%. These elements may not be contained, and thus the lower limit of the content of each of these elements is 0%.

### [Cr: 0.01%-2.00%]

Cr, an element effective for suppressing phase transformation at a high temperature and increasing high-strengthening, may be added. However, when the Cr content exceeds 2.00%, the hot formability is impaired so that the productivity is reduced. For this reason, the Cr content is preferably 2.00% or less, more preferably 1.20% or less. In order to sufficiently obtain a high-strengthening effect by Cr addition, the Cr content is preferably 0.01% or more, more preferably 0.10% or more.

### [Ni: 0.01%-2.00%]

Ni, an element effective for suppressing phase transformation at a high temperature and increasing high-strengthening, may be added. However, when the Ni content exceeds 2.00%, the weldability is impaired. For this reason, the Ni content is preferably 2.00% or less, more preferably 1.20% or less. In order to sufficiently obtain a high-strengthening effect by Ni addition, the Ni content is preferably 0.01% or more, more preferably 0.10% or more.

### [Cu: 0.01%-2.00%]

Cu, an element whose existence in a steel as fine particles increases the strength, may be added. However, when the Cu content exceeds 2.00%, the weldability is impaired. In addition, hot rolling also causes cracking due to surface red brittleness. For this reason, the Cu content is preferably 2.00% or less, more preferably 1.20% or less. In order to sufficiently obtain a high-strengthening effect by Cu addition, the Cu content is preferably 0.01% or more, more preferably 0.10% or more.

### [Mo: 0.01%-2.00%]

Mo, an element effective for suppressing phase transformation at a high temperature and increasing high-strengthening, may be added. However, when the Mo content exceeds 2.00%, the hot formability is impaired so that the productivity is reduced. For this reason, the Mo content is preferably 2.00% or less, more preferably 1.20% or less. In order to sufficiently obtain a high-strengthening effect by Mo addition, the Mo content is preferably 0.01% or more, more preferably 0.05% or more.

### [B: 0.0001%-0.0100%]

B, an element effective for suppressing phase transformation at a high temperature and increasing high-strengthening, may be added. However, when the B content exceeds 0.0100%, the hot formability is impaired and the productivity is lowered, and thus the B content is preferably 0.0100% or less. From the viewpoint of productivity, the B content is more preferably 0.0050% or less. In order to sufficiently obtain a high-strengthening effect by B addition, the B content is preferably 0.0001% or more. In order to further increase high-strengthening, the B content is more preferably 0.0005% or more.

### [W: 0.01%-2.00%]

W, an element effective for suppressing phase transformation at a high temperature and increasing high-strengthening, may be added. However, when the W content exceeds 2.00%, the hot formability is impaired so that the productivity is reduced. For this reason, the W content is preferably 2.00% or less, more preferably 1.20% or less. In order to sufficiently obtain a high-strengthening effect by W, the W content is preferably 0.01% or more, more preferably 0.10% or more.

Furthermore, the steel sheet of the present embodiment may contain one or two or more of Ca, Mg, Zr, and REM as other elements in a total amount of 0.0001%-0.0100%. The reason for addition of these elements is as follows.

REM, an abbreviation of Rare Earth Metal, here refers to an element belonging to the lanthanoid series.

One or two or more of Ca, Mg, Zr, and REM that are elements effective for improving the formability may be added. However, when the total content of one or two or more of Ca, Mg, Zr, and REM exceeds 0.0100%, the ductility may be impaired. Accordingly, the total content of respective elements is preferably 0.0100% or less, more preferably 0.0070% or less. On the other hand, even when the lower limit of the content of one or more of Ca, Mg, Zr, and REM is not particularly defined, the effects of the present invention are exhibited. In order to sufficiently obtain an effect of improving the formability of the steel sheet, the total content of these respective elements is preferably 0.0001% or more. From the viewpoint of formability, the total content of one or two or more of Ca, Mg, Zr, and REM is more preferably 0.0010% or more.

The chemical composition of the steel sheet according to the present embodiment can be determined by the following method. For example, the chemical composition (first chemical composition) of the steel sheet may be measured using ICP-AES (Inductively Coupled Plasma-Atomic Emission Spectrometry). In addition, Cand S may be measured using a combustion-infrared light absorption method, N may be measured using an inert gas fusion-thermal conductivity method, and O may be measured using an inert gas fusion-non-dispersive infrared light absorption method. The chemical composition of the steel sheet may be measured after removing the coated layer by mechanical grinding.

### (Tensile Strength of Steel Sheet is 740 MPa or More)

For the steel sheet according to the present embodiment, the tensile strength (TS) is 740 MPa or more. The strength of the steel sheet is preferably 780 MPa or more, more preferably 1000 MPa or more. The tensile strength is preferably 1250 MPa or less.

The tensile strength (TS) can be determined by taking a JIS No. 5 tensile test piece from the steel sheet in a direction perpendicular to the rolling direction and the sheet thickness direction and performing a tensile test according to JIS Z 2241:2011. The tensile strength is measured with the peeled-off coating.

(Area Fraction of SiO₂ is Less than 0.4% in Region from Surface of Steel Sheet Up to 3 μm in Sheet Thickness Direction)

For the steel sheet according to the present embodiment, the area fraction of SiO₂ is less than 0.4% in a region from the surface of the steel sheet up to 3 μm in the sheet thickness direction. When the area fraction of SiO₂ is 0.4% or more in a region from the surface of the steel sheet up to 3 μm in the sheet thickness direction, SiO₂ oxide is formed on the surface layer, and the coating is easily peeled off when the high strength steel sheet is processed. More preferably, the area fraction of SiO₂ is 0.2% or less in a region from the surface of the steel sheet up to 3 μm in the sheet thickness direction. The area fraction of SiO₂ is preferably 0.1% or more in a region from the surface of the steel sheet up to 3 μm in the sheet thickness direction.

### (Coated Layer)

A second chemical composition that is the chemical composition of the coated layer contains, by mass %, Al: 10%-13%, Mg: 3%-5%, and Si: 0.5% or less, with the balance being composed of Zn and impurities. The coated layer includes an Al—Fe-based interface alloy layer in contact with the steel sheet surface. In the coated layer, a portion excluding the Al—Fe-based interface alloy layer is referred to as a Zn—Al—Mg alloy layer. That is, the coated layer includes a Zn—Al—Mg alloy layer and an Al—Fe-based interface alloy layer. Hereinafter, the respective elements in the coated layer will be described.

### [Al: 10%-13%]

Al is an element that improves the corrosion resistance, suppresses Mg oxide dross of the coating bath, and contributes to the stability of the bath. Accordingly, the Al content is 10% or more. The Al content may be 11% or more. On the other hand, when Al is excessive, the Mg content and the Zn content relatively decrease, and the corrosion resistance may be deteriorated. Accordingly, the Al content is 13% or less. The Al content may be 12% or less.

### [Mg: 3%-5%]

Mg is an element essential for securing corrosion resistance. Accordingly, the Mg content is 3% or more. The Mg content may be 4% or more. On the other hand, when the Mg content is excessive, the formability and corrosion resistance may be deteriorated. Accordingly, the Mg content is 5% or less. The Mg content may be 4% or less.

### [Si: 0.5% or Less]

The Si content may be 0%. On the other hand, Si contributes to improvement in corrosion resistance. In addition, excessive growth of a brittle Al—Fe alloy layer at the interface between the coating and the base metal is suppressed, and the coating formability is also improved. Accordingly, the Si content may be 0.05% or more. On the other hand, when the Si content is excessive, the corrosion resistance may be deteriorated. Accordingly, the Si content is 0.5% or less, The Si content may be 0.4% or less. The Si content is preferably 0.10% or more.

### [Balance: Zn and Impurities]

The balance of the chemical composition (second chemical composition) of the coated layer according to the present embodiment is of Zn and impurities. Zn is an element that brings corrosion resistance to the coated layer. The impurity refers to a component that is contained in the raw material or mixed in the manufacturing step and not intentionally contained. For example, in the coated layer, a small amount of components other than Fe may be mixed as the impurity due to mutual atomic diffusion between the base steel sheet and the coating bath.

The chemical components of the coated layer according to the present embodiment are measured by the following method. First, an acid solution in which the coated layer is peeled off and dissolved is obtained using an acid containing an inhibitor that suppresses steel sheet corrosion. Next, the obtained acid solution is subjected to ICP analysis. As a result, the chemical composition (second chemical composition) of the coated layer can be determined. The type of acid is not particularly limited as long as the acid can dissolve the coated layer. The chemical composition measured by the above-described means is the average chemical composition of the entire coated layer. The formation reaction of the Al—Fe-based interface alloy layer is completed in the coating bath, and the thickness of the Al—Fe-based interface alloy layer is also sufficiently small with respect to the coated layer. Accordingly, unless a special heat treatment such as a heating alloying treatment is performed after coating, the average chemical composition of the entire coated layer is substantially equal to the chemical composition of the Zn—Al—Mg alloy layer, and the components of the Al—Fe-based interface alloy layer and the like can be ignored.

### [Al—Fe-Based Interface Alloy Layer]

The coated layer according to the present embodiment includes an Al—Fe-based interface alloy layer in contact with the steel sheet surface. The Al—Fe-based interface alloy layer is a layer that is formed on the surface of the steel sheet, specifically, between the steel sheet and the coated layer and contains as the microstructure an Al—Fe intermetallic compound as a main component. For example, the Al—Fe-based interface alloy layer is a layer in which an Al₅Fe₂ phase is the main phase. Here, an Al₅Fe₂ phase being the main phase means that 80% or more of the area fraction is the Al₅Fe₂ phase in the Al—Fe-based interface alloy layer.

The Al—Fe-based interface alloy layer is formed by mutual atomic diffusion between the steel sheet and the coating bath. In the present embodiment, since a certain concentration or more of Al is contained in the coating bath, the Al₅Fe₂ phase is formed most. However, since it takes time to diffuse atoms, the Fe concentration in the Al—Fe-based interface alloy layer is not uniform, and the Fe concentration may be high in a portion close to the steel sheet. Therefore, a small amount of an AlFe phase, an Al₃Fe phase, or the like may be partially contained in the Al—Fe-based interface alloy layer. In addition, since a certain concentration of Zn is also contained in the coating bath, a small amount of Zn or Si that is easily accumulated at an interface may be contained in the Al—Fe-based interface alloy layer.

When Si is contained in the coated layer, Si may be incorporated into the Al—Fe-based interface alloy layer to form an Al—Fe—Si intermetallic compound phase. An intermetallic compound phase to be identified is, for example, an AlFeSi phase, and a, B, q1, q2-AlFeSi phases and the like exist as isomers. Therefore, these AlFeSi phases and the like may be detected in the Al—Fe-based interface alloy layer.

The Al—Fe-based interface alloy layer affects securement of adhesion between the coated layer and the steel sheet, and the formability during working of the hot-dip coated steel sheet. In the present embodiment, the thickness of the Al—Fe-based interface alloy layer is 1.0-3.0 μm. When the Al—Fe-based interface alloy layer exceeds 3.0 μm, there is a risk that cracking may occur during processing. When the Al—Fe-based interface alloy layer is less than 1.0 μm, sufficient adhesion between the coated layer and the steel sheet may not be obtained.

The thickness of each layer of the coated layer according to the present embodiment and the area fraction of SiO₂ in a region from the surface of the steel sheet up to 3 μm in the sheet thickness direction can be evaluated by the following method.

First, a test piece is cut out by focused ion beam (FIB) processing such that the cutting direction is parallel to the sheet thickness direction and perpendicular to the sheet width direction, and the cross-sectional structure of the cut surface is observed with an electron probe microanalyzer-attached scanning electron microscope (SEM-EPMA) at a magnification at which each layer enters the observed visual field. When the Zn—Al—Mg alloy layer, the Al—Fe-based interface alloy layer, and the region from the surface of the steel sheet up to 3 μm in the sheet thickness direction do not enter the observed visual field, the cross-sectional structure is observed in a plurality of continuous visual fields. For example, observation may be performed in a visual field of about 1 μm×1 μm or more. The width in the sheet thickness direction and the width direction of the observation range is confirmed with reference to the scale bar at the time of SEM photographing. In addition, it is sufficient if the condition is an acceleration voltage of 20 kV. In the case of observation in only one view field, it is difficult to obtain average information of the steel sheet, and thus, it is sufficient to make a determination by observing 10 places separated from each other in a randomly selected view field.

In order to specify each layer in the cross-sectional structure of the steel sheet according to the present embodiment, line analysis is performed along the sheet thickness direction using an electron probe microanalyzer (EPMA), and quantitative analysis of the chemical composition of each layer is performed. The elements to be quantitatively analyzed are six elements of Fe, Si, O, Mg, Zn, and Al.

From the quantitative analysis result of SEM-EPMA described above, a region that is a layered region present at the deepest position in the sheet thickness direction and has an Fe content of 70 atom % or more and an O content of less than 30 atom % excluding measurement noise is determined to be a steel sheet, and a region having an Fe content of 10 atom % or more and less than 70 atom % and an O content of less than 30 atom % is defined as an Al—Fe-based interface alloy layer. A region where the Fe content is less than 10 atom % is defined as a Zn—Al—Mg alloy layer. The surface of the steel sheet is an interface between the steel sheet and the Al—Fe-based interface alloy layer. The thickness of the Al—Fe-based interface alloy layer is a length from the interface between the Zn—Al—Mg alloy layer and the Al—Fe-based interface alloy layer to the interface between the Al—Fe-based interface alloy layer and the steel sheet along the sheet thickness direction.

For example, SiO₂ can be identified by performing, with an electron probe microanalyzer (EPMA), line analysis of precipitates observed in the steel sheet along the sheet thickness direction of the steel sheet specified by the above method and performing quantitative analysis of chemical components. The elements to be quantitatively analyzed are six elements of Fe, Si, O, Mg, Zn, and Al.

From the quantitative analysis result of the EPMA described above, a region in which the Fe content is 15 atom % or less, the Si content is 30 atom % or more, and the O content is 55 atom % or more, excluding the measurement noise, is determined to be internally oxidized SiO₂. The area fraction of SiO₂ can be calculated from the total area of a region from the surface of the steel sheet up to 3 μm in the sheet thickness direction and the area of SiO₂ obtained (area of SiO₂/total area of a region from the surface of the steel sheet up to 3 μm in the sheet thickness direction).

### (Area Fraction of Coated Layer)

For the hot-dip coated steel sheet according to the present embodiment, the area fraction (coverage) of the coated layer to the steel sheet surface is preferably 99% or more. The area fraction of the coated layer can be evaluated in a surface observation image of the hot-dip coated layer using image analysis software.

### (Adhesion Amount of Coated Layer)

The adhesion amount of the coated layer per one surface may be, for example, within a range of 20 to 150 g/m². When the adhesion amount per one surface is 20 g/m² or more, the corrosion resistance of the hot-dip coated steel sheet can be further enhanced. On the other hand, when the adhesion amount per one surface is 150 g/m² or less, the formability of the hot-dip coated steel sheet can be further improved.

The adhesion amount of the coated layer according to the present embodiment is measured by the following method. First, the area of the coated layer of the hot-dip coated steel sheet before peeling of the coated layer, and the weight of the hot-dip coated steel sheet are measured. Next, the coated layer is peeled off using an acid containing an inhibitor that suppresses corrosion of the steel sheet. The adhesion amount (g/m²) of the coated layer is obtained by measuring and calculating the weight of the hot-dip coated steel sheet after peeling-off.

### <Method for Manufacturing Hot-Dip Coated Steel Sheet>

Next, the method for manufacturing a hot-dip coated steel sheet according to the present embodiment will be described, but the method for manufacturing a hot-dip coated steel sheet according to the present embodiment is not particularly limited. For example, according to the manufacturing conditions described below, the hot-dip coated steel sheet according to the present embodiment can be obtained.

The method for manufacturing a hot-dip coated steel sheet according to the present embodiment includes a continuous coating step of coating a base steel sheet having the first chemical composition described above using a continuous hot-dip galvanizing line with all-radiant tube heating system, in which in the continuous coating step, reduction annealing is performed on the base steel sheet in an atmosphere of 2-10 vol % of hydrogen and 0.002 vol %-0.05 vol % of water vapor under a reduction condition of a maximum temperature of a surface temperature of the base steel sheet of 775° C. or more and a retention time at 750° C. or more of 30 seconds or more, and the base steel sheet after the reduction annealing is immersed in a coating bath having the second chemical composition at a coating bath temperature of 470° C.-520° C. and an entry material temperature of 470° C.-520° C., or a coating bath temperature of 450° C. or more and less than 470° C. and an entry material temperature of 490° C.-520° C. for 3 seconds or more. Specifically, the chemical composition (second chemical composition) of the coating bath contains, by mass %, Al: 10%-13%, Mg: 3%-5%, and Si: 0.5% or less, with the balance being of Zn and impurities.

### (Base Steel Sheet)

As the base steel sheet, a steel sheet having the first chemical composition described above and having a tensile strength (for example, the tensile strength of the steel sheet after the reduction annealing described above) of 740 MPa or more is used. The base steel sheet is not particularly limited as long as the base steel sheet has the first chemical composition described above and has, for example, a tensile strength of 740 MPa or more. As the base steel sheet, for example, a hot-rolled steel sheet obtained by steelmaking a slab having the first chemical composition described above and performing hot rolling may be used. Alternatively, a cold-rolled steel sheet obtained by cold rolling the obtained hot-rolled steel sheet may be used.

(Continuous Hot-Dip Galvanizing Line with all-Radiant Tube Heating System)

An all radiant tube (ART) type continuous hot-dip galvanizing device according to the present embodiment does not have an oxidation zone in a continuous furnace. Therefore, when the annealing dew point is appropriately controlled, formation of Si internal oxide on the surface layer of the steel sheet can be suppressed. As a result, the area fraction of SiO₂ can be less than 0.4% in a region from the surface of the steel sheet up to 3 μm in the sheet thickness direction.

In the continuous coating step according to the present embodiment, reduction annealing is performed in an atmosphere of 2-10 vol % of hydrogen and 0.002 vol %-0.05 vol % of water vapor. At this time, the maximum temperature of the surface temperature of the base steel sheet is adjusted to 775° C. or more, and the retention time at 750° C. or more is adjusted to 30 seconds or more. By reducing the base steel sheet under such a reduction condition, the area fraction of SiO₂ can be less than 0.4% in a region from the surface of the steel sheet up to 3 μm in the sheet thickness direction. The maximum temperature may be 900 degrees or less. The retention time may be 150 seconds or less. By adjusting the maximum temperature to 775° C. or more and the retention time at 750° C. or more to 30 seconds or more, the tensile strength of the steel sheet can be 740 MPa or more. When the water vapor concentration is more than 0.05 vol %, the coating wettability is improved, but the formability is unfortunately deteriorated, In order to obtain the hot-dip coated steel sheet according to the present embodiment, the water vapor concentration is 0.002 vol % or more.

The dew point during the reduction annealing is preferably −30° C. or lower. By adjusting the dew point to −30° C. or less, the area fraction of SiO₂ can be easily less than 0.4% in a region from the surface of the steel sheet up to 3 μm in the sheet thickness direction.

The log (PH₂O/PH₂) at the time of reduction annealing is preferably −2.20 to −1.00. Here, PH₂O represents a partial pressure of water vapor, and PH₂ represents a partial pressure of hydrogen. When the log (PH₂O/PH₂) at the time of reduction annealing is −2.20 to −1.00, the area fraction of SiO₂ can be easily less than 0.4% in a region from the surface of the steel sheet up to 3 μm in the sheet thickness direction.

The base steel sheet after reduction annealing is immersed in a coating bath having the same composition as the second chemical composition described above under the following condition A or condition B for 3 seconds or more. The immersion time may be 10 seconds or less. By immersing a base steel sheet having the first chemical composition under the condition A or the condition B for an immersion time of 3 seconds or more, the coating wettability can be improved. Diffusion of Fe into the coating bath and reaction with the coating bath form an Al—Fe-based interface alloy layer at the interface between the coated layer and the steel sheet. In addition, the Al—Fe-based interface alloy layer can be 1-3 μm. When the coating bath temperature exceeds 520° C., the thickness of the Al—Fe-based interface alloy layer exceeds 3 μm, so that the formability of the hot-dip coated steel sheet according to the present embodiment is deteriorated.

Condition A: Coating bath temperature 470° C. to 520° C. and entry material temperature 470° C. to 520° C.

Condition B: Coating bath temperature 450° C. to less than 470° C. and entry material temperature of 490° C. to 520° C.

The immersion time in the coating bath is 3 seconds or more. When the immersion time in the coating bath is less than 3 seconds, the coating area fraction is not 99% or more.

Next, the base steel sheet to which the molten metal adheres is pulled up from the coating bath. The adhesion amount of the coated layer is controlled by performing gas wiping on the steel sheet to which the molten metal adheres. The adhesion amount of the coated layer is not particularly limited, and can be, for example, within the above-described range.

Next, after the adhesion amount of the coated layer is controlled, the adhered molten metal is cooled to be solidified. Cooling is continuously performed on the steel sheet to which the molten metal adheres immediately after being pulled up from the coating bath until the temperature of the molten metal reaches 300° C. from the bath temperature. The cooling method may be performed by spraying nitrogen, air, or a hydrogen-helium mixed gas, or may be mist cooling. The cooling condition at less than 300° C. is not particularly limited, but mist cooling may be subsequently performed, or air cooling or natural cooling may be performed. The average cooling rate between the bath temperature and 300° C. is, for example, 10° C./seC or more.

The hot-dip coated steel sheet of the present disclosure is exceptional in formability and external appearance, and is suppressed in formation of SiO₂ oxide, and thus can be suitably used for a frame of a solar cell and the like. The coating adhesion of the steel sheet is so exceptional that the steel sheet can be more strongly processed than the conventional steel sheet, the number of parts can be reduced, and the component-manufacturing cost and the construction cost for assembling components on site can be proposed.

### EXAMPLES

Hereinafter, examples of the present invention will be described. However, the conditions in Examples are merely one condition example adopted to confirm the operability and effects of the present invention. The present invention is not limited to this one condition example. The present invention can adopt various conditions as long as the object of the present invention is achieved without departing from the gist of the present invention.

As the base steel sheet, steel sheets having a chemical composition described in Table 1 were used. Next, reduction annealing was performed on the base steel sheets under conditions described in Tables 2A and 2B. The base steel sheets after reduction annealing were coated under conditions described in Tables 3A and 3B, the base steel sheets pulled up from the coating bath were subjected to gas wiping to adjust the adhesion amount, followed by cooling with nitrogen gas. For the coating other than Experiment No. 26, a continuous hot-dip galvanizing line with all-radiant tube heating system having no oxidation zone was used. No. 26 was coated using a continuous hot-dip galvanizing device having an oxidation zone.

(Evaluation of Chemical Composition of Coated Layer, Thickness of Al—Fe-Based Interface Alloy Layer, and Area Fraction of SiO₂ in Region from Surface of Steel Sheet Up to 3 μm in Sheet Thickness Direction)

The chemical composition of the obtained coated layer, the thickness of the Al—Fe-based interface alloy layer, and the area fraction of SiO₂ in a region from the surface of the steel sheet up to 3 μm in the sheet thickness direction were evaluated by the above-described means. The obtained results are shown in Tables 4A, 4B, 4C, and 4D.

### (Tensile Strength)

The tensile strength (TS) was evaluated for the steel sheet after the coated layer was peeled off from the obtained hot-dip coated steel sheet. The peeling was performed by the method for use in analyzing the chemical composition of the coated layer described above. The tensile strength was obtained by taking a JIS No. 5 tensile test piece in a direction perpendicular to the rolling direction of the steel sheet and performing a tensile test according to JIS Z 2241:2011. The obtained results are shown in Tables 4A, 4B, 4C, and 4D. Similarly, the tensile strength of the base steel sheet after reduction annealing was also evaluated. Obtained results are shown in Table 1.

### (Evaluation of Coating)

In the evaluation of coating, when the area fraction of the coated layer was 99% or more, it was evaluated as good (◯), when the area fraction of the coated layer was 67% or more and less than 99%, it was evaluated as average (Δ), and when the area fraction of the coated layer was less than 67%, it was evaluated as poor (x). An area fraction of the coated layer of 99% or more was evaluated as acceptable. The obtained results are shown in Tables 4A, 4B, 4C, and 4D.

### (Evaluation of Formability)

The formability was evaluated by the adhesion of the coated layer. A coated layer having an area fraction of 99% or more was evaluated. Each steel sheet was bent by 180° bending in accordance with JIS G 3323:2019. The inside interval of the bent steel sheet was 3T (number of sheets). A tape was attached to the bent steel sheet, and then evaluation was performed based on the area fraction of the coated layer remaining after peeling off the tape (remaining area fraction). When the remaining area fraction of the coated layer was 99% or more, it was evaluated as good (◯), when the remaining area fraction of the coated layer was 67% or more and less than 99%, it was evaluated as average (Δ), and when the remaining area fraction of the coated layer was less than 67%, it was evaluated as poor (x). A coated layer having a remaining area fraction of 99% or more was evaluated as acceptable because of exceptional formability. A layer not evaluated because of bare spots was rated “-”. The obtained results are shown in Tables 4A, 4B, 4C, and 4D.

As shown in Tables 4A, 4B, 4C, and 4D, Examples 4-7, 10-12, 16-19, 29, 32, 35, 38, 41, 44, 47, 50, 53, 56, 59, 62, 65, 67, and 68 according to the present invention in which the chemical composition of the steel sheet, the chemical composition of the coated layer, the thickness of the Al—Fe-based interface alloy layer, and the area fraction of SiO₂ in a region from the surface of the steel sheet up to 3 μm in the sheet thickness direction were appropriately controlled were exceptional in both external appearance and formability. In addition, since coating was performed using a continuous hot-dip galvanizing line with all-radiant tube heating system, the area fraction of SiO₂ in a region from the surface of the steel sheet up to 3 μm in the sheet thickness direction was low, and formation of SiO₂ oxide was suppressed. In Examples, the adhesion amount per one surface of the coated layer was, for example, within a range of 20-150 g/m². In Comparative Example 27, the content of Si in the steel sheet was so low that even when the temperature of the coating bath and the sheet temperature were out of the ranges, the area fraction of the coated layer was 99% or more, but the tensile strength was low.

TABLE 1

| | | | | | | | | | | | | | | | | | Tensile |
|---|---|---|---|---|---|---|---|---|---|---|---|---|---|---|---|---|---|
| | | | | | | | | | | | | | | | | | strength |
| | Chemical composition (mass %) balance: Fe and impurities | | | | | | | | | | | | | | | | after reduction |
| Steel | | | | | | | | | | | | | | | | Ca + Mg + | annealing |
| type | C | Mn | Si | P | S | Al | Ti | Nb | V | Cr | Ni | Cu | Mo | B | W | Zr + REM | (MPa) |
| A | 0.09 | 2.45 | 0.44 | 0.011 | 0.0025 | 0.022 | | | | | | | | 0.0021 | | | 780 |
| B | 0.10 | 0.10 | 0 | 0.008 | 0.0059 | 0.035 | | | | | | | | | | | 390 |
| C | 0.19 | 2.20 | 1.45 | 0.001 | 0.0030 | 0.030 | | | | | | | | | | | 980 |
| D | 0.16 | 1.32 | 0.40 | 0.017 | 0.0030 | 0.091 | 0.021 | | | | | | | 0.0079 | | | 820 |
| E | 0.09 | 2.40 | 0.40 | 0.001 | 0.0025 | 0.020 | | 0.030 | | | | | | | | | 830 |
| F | 0.09 | 2.40 | 0.40 | 0.001 | 0.0025 | 0.020 | | | 0.110 | | | | | | | | 830 |
| G | 0.09 | 2.40 | 0.40 | 0.001 | 0.0025 | 0.020 | | | | 0.09 | | | | | | | 830 |
| H | 0.09 | 2.40 | 0.40 | 0.001 | 0.0025 | 0.020 | | | | | | | 0.03 | | | | 850 |
| I | 0.09 | 2.40 | 0.40 | 0.001 | 0.0025 | 0.020 | | | | | | | | | 0.02 | | 850 |
| J | 0.09 | 2.40 | 0.40 | 0.001 | 0.0025 | 0.020 | | | | | | | | | | 0.0050 Ca + | 820 |
| | | | | | | | | | | | | | | | | 0.0050 Mg | |
| K | 0.09 | 2.40 | 0.40 | 0.001 | 0.0025 | 0.020 | | | | | | | | | | 0.0070 Zr | 820 |
| L | 0.09 | 2.40 | 0.40 | 0.001 | 0.0025 | 0.020 | | | | | | | | | | 0.0080 REM | 820 |
| M | 0.09 | 2.40 | 0.40 | 0.001 | 0.0025 | 0.020 | | | | | 0.60 | 0.30 | | | | | 840 |
| N | 0.09 | 2.40 | 0.40 | 0.001 | 0.0025 | 0.020 | | | | | 1.00 | 0.00 | | | | | 840 |

TABLE 2A

| | | | Retention | | | | |
|---|---|---|---|---|---|---|---|
| | | Maximum | time at | | | | |
| | | annealing | 750° C. | Hydrogen | Water vapor | Dew | |
| Experiment | Steel | temperature | or more | concentration | concentration | point | log |
| No | type | (° C.) | (seconds) | (vol %) | (vol %) | (° C.) | (PH₂O/PH₂) |
| 1 | A | 800 | 78 | 3 | 0.02% | −40 | −2.20 |
| 2 | A | 800 | 78 | 3 | 0.02% | −40 | −2.20 |
| 3 | A | 800 | 78 | 3 | 0.02% | −40 | −2.20 |
| 4 | A | 800 | 78 | 3 | 0.02% | −40 | −2.20 |
| 5 | A | 800 | 78 | 3 | 0.02% | −40 | −2.20 |
| 6 | A | 800 | 78 | 3 | 0.02% | −40 | −2.20 |
| 7 | A | 800 | 78 | 3 | 0.02% | −40 | −2.20 |
| 8 | A | 800 | 78 | 3 | 0.02% | −40 | −2.20 |
| 9 | A | 800 | 78 | 3 | 0.02% | −40 | −2.20 |
| 10 | A | 800 | 78 | 3 | 0.02% | −40 | −2.20 |
| 11 | A | 800 | 78 | 3 | 0.02% | −40 | −2.20 |
| 12 | A | 800 | 78 | 8 | 0.05% | −30 | −2.20 |
| 13 | A | 800 | 78 | 8 | 0.05% | −30 | −2.20 |
| 14 | A | 800 | 78 | 8 | 0.05% | −30 | −2.20 |
| 15 | A | 800 | 78 | 8 | 0.05% | −30 | −2.20 |
| 16 | A | 800 | 78 | 8 | 0.05% | −30 | −2.20 |
| 17 | A | 800 | 78 | 8 | 0.05% | −30 | −2.20 |
| 18 | A | 800 | 78 | 8 | 0.05% | −30 | −2.20 |
| 19 | A | 800 | 78 | 8 | 0.05% | −30 | −2.20 |
| 20 | A | 800 | 78 | 8 | 0.05% | −30 | −2.20 |
| 21 | A | 800 | 78 | 8 | 0.05% | −30 | −2.20 |
| 22 | A | 800 | 78 | 3 | 0.28% | −10 | −1.03 |
| 23 | A | 800 | 78 | 3 | 0.60% | 0 | −0.70 |
| 24 | A | 750 | 0 | 3 | 0.02% | −40 | −2.20 |
| 25 | A | 775 | 10 | 3 | 0.02% | −40 | −2.20 |
| 26 | A | 800 | 78 | 8 | 0.05% | −30 | −2.20 |
| 27 | B | 800 | 15 | 3 | 0.02% | −40 | −2.20 |
| 28 | C | 800 | 78 | 3 | 0.02% | −40 | −2.20 |
| 29 | C | 800 | 78 | 3 | 0.02% | −40 | −2.20 |
| 30 | C | 800 | 78 | 3 | 0.60% | 0 | −0.70 |
| 31 | D | 800 | 78 | 3 | 0.02% | −40 | −2.20 |
| 32 | D | 800 | 78 | 3 | 0.02% | −40 | −2.20 |
| 33 | D | 800 | 78 | 3 | 0.60% | 0 | −0.70 |
| 34 | E | 800 | 78 | 3 | 0.02% | −40 | −2.20 |
| 35 | E | 800 | 78 | 3 | 0.02% | −40 | −2.20 |

The underline represents that the value is out of the scope of the present invention.

TABLE 2B

| | | | Retention | | | | |
|---|---|---|---|---|---|---|---|
| | | Maximum | time at | | | | |
| | | annealing | 750° C. | Hydrogen | Water vapor | Dew | |
| Experiment | Steel | temperature | or more | concentration | concentration | point | log |
| No | type | (° C.) | (seconds) | (vol %) | (vol %) | (° C.) | (PH₂O/PH₂) |
| 36 | E | 800 | 78 | 3 | 0.60% | 0 | −0.70 |
| 37 | F | 800 | 78 | 3 | 0.02% | −40 | −2.20 |
| 38 | F | 800 | 78 | 3 | 0.02% | −40 | −2.20 |
| 39 | F | 800 | 78 | 3 | 0.60% | 0 | −0.70 |
| 40 | G | 800 | 78 | 3 | 0.02% | −40 | −2.20 |
| 41 | G | 800 | 78 | 3 | 0.02% | −40 | −2.20 |
| 42 | G | 800 | 78 | 3 | 0.60% | 0 | −0.70 |
| 43 | H | 800 | 78 | 3 | 0.02% | −40 | −2.20 |
| 44 | H | 800 | 78 | 3 | 0.02% | −40 | −2.20 |
| 45 | H | 800 | 78 | 3 | 0.60% | 0 | −0.70 |
| 46 | I | 800 | 78 | 3 | 0.02% | −40 | −2.20 |
| 47 | I | 800 | 78 | 3 | 0.02% | −40 | −2.20 |
| 48 | I | 800 | 78 | 3 | 0.60% | 0 | −0.70 |
| 49 | J | 800 | 78 | 3 | 0.02% | −40 | −2.20 |
| 50 | J | 800 | 78 | 3 | 0.02% | −40 | −2.20 |
| 51 | J | 800 | 78 | 3 | 0.60% | 0 | −0.70 |
| 52 | K | 800 | 78 | 3 | 0.02% | −40 | −2.20 |
| 53 | K | 800 | 78 | 3 | 0.02% | −40 | −2.20 |
| 54 | K | 800 | 78 | 3 | 0.60% | 0 | −0.70 |
| 55 | L | 800 | 78 | 3 | 0.02% | −40 | −2.20 |
| 56 | L | 800 | 78 | 3 | 0.02% | −40 | −2.20 |
| 57 | L | 800 | 78 | 3 | 0.60% | 0 | −0.70 |
| 58 | M | 800 | 78 | 3 | 0.02% | −40 | −2.20 |
| 59 | M | 800 | 78 | 3 | 0.02% | −40 | −2.20 |
| 60 | M | 800 | 78 | 3 | 0.60% | 0 | −0.70 |
| 61 | N | 800 | 78 | 3 | 0.02% | −40 | −2.20 |
| 62 | N | 800 | 78 | 3 | 0.02% | −40 | −2.20 |
| 63 | N | 800 | 78 | 3 | 0.60% | 0 | −0.70 |
| 64 | A | 800 | 78 | 3 | 0.02% | −40 | −2.20 |
| 65 | A | 800 | 78 | 3 | 0.02% | −40 | −2.20 |
| 66 | A | 800 | 78 | 3 | 0.02% | −40 | −2.20 |
| 67 | A | 800 | 78 | 3 | 0.02% | −40 | −2.20 |
| 68 | A | 800 | 78 | 3 | 0.003% | −56 | −2.98 |

The underline represents that the value is out of the scope of the present invention.

TABLE 3A

| | Bath temperature | Entry material temperature | Immersion time |
|---|---|---|---|
| | (° C.) | (° C.) | (seconds) |
| 1 | 430 | 430 | 3 |
| 2 | 460 | 460 | 3 |
| 3 | 460 | 480 | 3 |
| 4 | 460 | 500 | 3 |
| 5 | 480 | 480 | 3 |
| 6 | 480 | 500 | 3 |
| 7 | 500 | 500 | 3 |
| 8 | 560 | 500 | 3 |
| 9 | 550 | 550 | 3 |
| 10 | 480 | 510 | 3 |
| 11 | 510 | 510 | 3 |
| 12 | 460 | 510 | 3 |
| 13 | 430 | 430 | 3 |
| 14 | 460 | 460 | 3 |
| 15 | 460 | 480 | 3 |
| 16 | 460 | 500 | 3 |
| 17 | 480 | 480 | 3 |
| 18 | 480 | 500 | 3 |
| 19 | 500 | 500 | 3 |
| 20 | 480 | 480 | 1 |
| 21 | 460 | 500 | 1 |
| 22 | 460 | 460 | 3 |
| 23 | 460 | 460 | 3 |
| 24 | 500 | 500 | 3 |
| 25 | 500 | 500 | 3 |
| 26 | 440 | 440 | 3 |
| 27 | 430 | 430 | 3 |
| 28 | 440 | 440 | 3 |
| 29 | 510 | 510 | 3 |
| 30 | 440 | 440 | 3 |
| 31 | 450 | 450 | 3 |
| 32 | 500 | 500 | 3 |
| 33 | 450 | 450 | 3 |
| 34 | 450 | 450 | 3 |
| 35 | 500 | 500 | 3 |

The underline represents that the value is out of the scope of the present invention.

TABLE 3B

| | Bath temperature | Entry material temperature | Immersion time |
|---|---|---|---|
| | (° C.) | (° C.) | (seconds) |
| 36 | 450 | 450 | 3 |
| 37 | 450 | 450 | 3 |
| 38 | 500 | 500 | 3 |
| 39 | 450 | 450 | 3 |
| 40 | 450 | 450 | 3 |
| 41 | 500 | 500 | 3 |
| 42 | 450 | 450 | 3 |
| 43 | 450 | 450 | 3 |
| 44 | 500 | 500 | 3 |
| 45 | 450 | 450 | 3 |
| 46 | 450 | 450 | 3 |
| 47 | 500 | 500 | 3 |
| 48 | 450 | 450 | 3 |
| 49 | 450 | 450 | 3 |
| 50 | 500 | 500 | 3 |
| 51 | 450 | 450 | 3 |
| 52 | 450 | 450 | 3 |
| 53 | 500 | 500 | 3 |
| 54 | 450 | 450 | 3 |
| 55 | 450 | 450 | 3 |
| 56 | 500 | 500 | 3 |
| 57 | 450 | 450 | 3 |
| 58 | 450 | 450 | 3 |
| 59 | 500 | 500 | 3 |
| 60 | 450 | 450 | 3 |
| 61 | 450 | 450 | 3 |
| 62 | 500 | 500 | 3 |
| 63 | 450 | 450 | 3 |
| 64 | 430 | 430 | 3 |
| 65 | 480 | 480 | 3 |
| 66 | 430 | 430 | 3 |
| 67 | 480 | 480 | 3 |
| 68 | 480 | 480 | 3 |

The underline represents that the value is out of the scope of the present invention.

TABLE 4A

| | | | | | Area fraction of | | | | |
|---|---|---|---|---|---|---|---|---|---|
| | | | | Thickness of | SiO₂ in region from | | | | |
| | | | | Al—Fe-based | surface of steel sheet | Tensile | | | |
| | Coated layer chemical composition | | | interface | up to 3 μm in sheet | strength of | | Evaluation | |
| Experiment | (mass %) balance: Zn and impurities | | | alloy layer | thickness direction | steel sheet | Evaluation | of | |
| No | Al | Mg | Si | (μm) | (%) | (MPa) | of coating | formability | Note |
| 1 | 11 | 3 | 0.5 | 0.2 | 0.1 | 780 | X | — | Comparative |
| | | | | | | | | | Example |
| 2 | 11 | 3 | 0.5 | 0.2 | 0.1 | 780 | Δ | — | Comparative |
| | | | | | | | | | Example |
| 3 | 11 | 3 | 0.5 | 0.3 | 0.1 | 780 | Δ | — | Comparative |
| | | | | | | | | | Example |
| 4 | 11 | 3 | 0.5 | 1.0 | 0.1 | 780 | ◯ | ◯ | Example |
| 5 | 11 | 3 | 0.5 | 1.0 | 0.1 | 780 | ◯ | ◯ | Example |
| 6 | 11 | 3 | 0.5 | 1.5 | 0.1 | 780 | ◯ | ◯ | Example |
| 7 | 11 | 3 | 0.5 | 2.0 | 0.1 | 780 | ◯ | ◯ | Example |
| 8 | 11 | 3 | 0.5 | 4.0 | 0.1 | 780 | ◯ | X | Comparative |
| | | | | | | | | | Example |
| 9 | 11 | 3 | 0.5 | 5.0 | 0.1 | 780 | ◯ | X | Comparative |
| | | | | | | | | | Example |
| 10 | 11 | 3 | 0.5 | 1.8 | 0.1 | 780 | ◯ | ◯ | Example |
| 11 | 11 | 3 | 0.5 | 2.1 | 0.1 | 780 | ◯ | ◯ | Example |
| 12 | 11 | 3 | 0.5 | 1.5 | 0.1 | 780 | ◯ | ◯ | Example |
| 13 | 11 | 3 | 0.5 | 0.2 | 0.1 | 780 | X | — | Comparative |
| | | | | | | | | | Example |
| 14 | 11 | 3 | 0.5 | 0.2 | 0.1 | 780 | Δ | — | Comparative |
| | | | | | | | | | Example |
| 15 | 11 | 3 | 0.5 | 0.3 | 0.1 | 780 | Δ | — | Comparative |
| | | | | | | | | | Example |
| 16 | 11 | 3 | 0.5 | 1.0 | 0.1 | 780 | ◯ | ◯ | Example |
| 17 | 11 | 3 | 0.5 | 1.0 | 0.1 | 780 | ◯ | ◯ | Example |
| 18 | 11 | 3 | 0.5 | 1.5 | 0.1 | 780 | ◯ | ◯ | Example |
| 19 | 11 | 3 | 0.5 | 2.0 | 0.1 | 780 | ◯ | ◯ | Example |
| 20 | 11 | 3 | 0.5 | 0.5 | 0.1 | 780 | X | — | Comparative |
| | | | | | | | | | Example |

The underline represents that the value is out of the scope of the present invention.

TABLE 4B

| | | | | | Area fraction of | | | | |
|---|---|---|---|---|---|---|---|---|---|
| | | | | Thickness of | SiO₂ in region from | | | | |
| | | | | Al—Fe-based | surface of steel sheet | Tensile | | | |
| | Coated layer chemical composition | | | interface | up to 3 μm in sheet | strength of | | Evaluation | |
| Experiment | (mass %) balance: Zn and impurities | | | alloy layer | thickness direction | steel sheet | Evaluation | of | |
| No | Al | Mg | Si | (μm) | (%) | (MPa) | of coating | formability | Note |
| 21 | 11 | 3 | 0.5 | 0.5 | 0.1 | 780 | X | — | Comparative |
| | | | | | | | | | Example |
| 22 | 11 | 3 | 0.5 | 0.9 | 0.8 | 780 | ◯ | Δ | Comparative |
| | | | | | | | | | Example |
| 23 | 11 | 3 | 0.5 | 1.3 | 1.0 | 780 | ◯ | X | Comparative |
| | | | | | | | | | Example |
| 24 | 11 | 3 | 0.5 | 2.0 | 0.1 | 650 | ◯ | ◯ | Comparative |
| | | | | | | | | | Example |
| 25 | 11 | 3 | 0.5 | 2.0 | 0.1 | 700 | ◯ | ◯ | Comparative |
| | | | | | | | | | Example |
| 26 | 11 | 3 | 0.5 | 1.0 | 0.4 | 780 | ◯ | Δ | Comparative |
| | | | | | | | | | Example |
| 27 | 11 | 3 | 0.5 | 0.1 | 0 | 390 | ◯ | ◯ | Comparative |
| | | | | | | | | | Example |
| 28 | 11 | 3 | 0.5 | 0.3 | 0.1 | 390 | X | — | Comparative |
| | | | | | | | | | Example |
| 29 | 11 | 3 | 0.5 | 2.2 | 0.1 | 980 | ◯ | ◯ | Example |
| 30 | 11 | 3 | 0.5 | 1.6 | 1.6 | 980 | ◯ | X | Comparative |
| | | | | | | | | | Example |
| 31 | 11 | 3 | 0.5 | 0.2 | 0.1 | 980 | Δ | — | Comparative |
| | | | | | | | | | Example |
| 32 | 11 | 3 | 0.5 | 2.0 | 0.1 | 820 | ◯ | ◯ | Example |
| 33 | 11 | 3 | 0.5 | 1.4 | 0.8 | 820 | ◯ | X | Comparative |
| | | | | | | | | | Example |
| 34 | 11 | 3 | 0.5 | 0.2 | 0.1 | 820 | Δ | — | Comparative |
| | | | | | | | | | Example |
| 35 | 11 | 3 | 0.5 | 2.0 | 0.1 | 830 | ◯ | ◯ | Example |
| 36 | 11 | 3 | 0.5 | 1.3 | 0.8 | 830 | ◯ | X | Comparative |
| | | | | | | | | | Example |
| 37 | 11 | 3 | 0.5 | 0.2 | 0.1 | 830 | Δ | — | Comparative |
| | | | | | | | | | Example |
| 38 | 11 | 3 | 0.5 | 2.0 | 0.1 | 830 | ◯ | ◯ | Example |
| 39 | 11 | 3 | 0.5 | 1.5 | 0.8 | 830 | ◯ | X | Comparative |
| | | | | | | | | | Example |
| 40 | 11 | 3 | 0.5 | 0.2 | 0.1 | 830 | Δ | — | Comparative |
| | | | | | | | | | Example |

The underline represents that the value is out of the scope of the present invention.

TABLE 4C

| | | | | | Area fraction of | | | | |
|---|---|---|---|---|---|---|---|---|---|
| | | | | Thickness of | SiO₂ in region from | | | | |
| | | | | Al—Fe-based | surface of steel sheet | Tensile | | | |
| | Coated layer chemical composition | | | interface | up to 3 μm in sheet | strength of | | Evaluation | |
| Experiment | (mass %) balance: Zn and impurities | | | alloy layer | thickness direction | steel sheet | Evaluation | of | |
| No | Al | Mg | Si | (μm) | (%) | (MPa) | of coating | formability | Note |
| 41 | 11 | 3 | 0.5 | 2.0 | 0.1 | 830 | ◯ | ◯ | Example |
| 42 | 11 | 3 | 0.5 | 1.3 | 0.8 | 830 | ◯ | X | Comparative |
| | | | | | | | | | Example |
| 43 | 11 | 3 | 0.5 | 0.2 | 0.1 | 830 | Δ | — | Comparative |
| | | | | | | | | | Example |
| 44 | 11 | 3 | 0.5 | 1.9 | 0.1 | 850 | ◯ | ◯ | Example |
| 45 | 11 | 3 | 0.5 | 1.4 | 0.8 | 850 | ◯ | X | Comparative |
| | | | | | | | | | Example |
| 46 | 11 | 3 | 0.5 | 0.2 | 0.1 | 850 | Δ | — | Comparative |
| | | | | | | | | | Example |
| 47 | 11 | 3 | 0.5 | 1.9 | 0.1 | 850 | ◯ | ◯ | Example |
| 48 | 11 | 3 | 0.5 | 1.3 | 0.8 | 850 | ◯ | X | Comparative |
| | | | | | | | | | Example |
| 49 | 11 | 3 | 0.5 | 0.2 | 0.1 | 850 | Δ | — | Comparative |
| | | | | | | | | | Example |
| 50 | 11 | 3 | 0.5 | 2.1 | 0.1 | 820 | ◯ | ◯ | Example |
| 51 | 11 | 3 | 0.5 | 1.2 | 0.8 | 820 | ◯ | X | Comparative |
| | | | | | | | | | Example |
| 52 | 11 | 3 | 0.5 | 0.2 | 0.1 | 820 | Δ | — | Comparative |
| | | | | | | | | | Example |
| 53 | 11 | 3 | 0.5 | 2.2 | 0.1 | 820 | ◯ | ◯ | Example |
| 54 | 11 | 3 | 0.5 | 1.3 | 0.8 | 820 | ◯ | X | Comparative |
| | | | | | | | | | Example |
| 55 | 11 | 3 | 0.5 | 0.2 | 0.1 | 820 | Δ | — | Comparative |
| | | | | | | | | | Example |
| 56 | 11 | 3 | 0.5 | 2.1 | 0.1 | 820 | ◯ | ◯ | Example |
| 57 | 11 | 3 | 0.5 | 1.5 | 0.8 | 820 | ◯ | X | Comparative |
| | | | | | | | | | Example |
| 58 | 11 | 3 | 0.5 | 0.2 | 0.1 | 820 | Δ | — | Comparative |
| | | | | | | | | | Example |
| 59 | 11 | 3 | 0.5 | 2.2 | 0.1 | 840 | ◯ | ◯ | Example |
| 60 | 11 | 3 | 0.5 | 1.3 | 0.8 | 840 | ◯ | X | Comparative |
| | | | | | | | | | Example |

The underline represents that the value is out of the scope of the present invention.

TABLE 4D

| | | | | | Area fraction of | | | | |
|---|---|---|---|---|---|---|---|---|---|
| | | | | Thickness of | SiO₂ in region from | | | | |
| | | | | Al—Fe-based | surface of steel sheet | Tensile | | | |
| | Coated layer chemical composition | | | interface | up to 3 μm in sheet | strength of | | Evaluation | |
| Experiment | (mass %) balance: Zn and impurities | | | alloy layer | thickness direction | steel sheet | Evaluation | of | |
| No | Al | Mg | Si | (μm) | (%) | (MPa) | of coating | formability | Note |
| 61 | 11 | 3 | 0.5 | 0.2 | 0.1 | 840 | Δ | — | Comparative |
| | | | | | | | | | Example |
| 62 | 11 | 3 | 0.5 | 2.1 | 0.1 | 840 | ◯ | ◯ | Example |
| 63 | 11 | 3 | 0.5 | 1.5 | 0.8 | 840 | ◯ | X | Comparative |
| | | | | | | | | | Example |
| 64 | 13 | 5 | 0.3 | 0.2 | 0.1 | 780 | X | — | Comparative |
| | | | | | | | | | Example |
| 65 | 11 | 3 | 0.5 | 1.0 | 0.1 | 780 | ◯ | ◯ | Example |
| 66 | 10 | 3 | 0 | 0.2 | 0.1 | 780 | X | — | Comparative |
| | | | | | | | | | Example |
| 67 | 11 | 3 | 0.5 | 1.0 | 0.1 | 780 | ◯ | ◯ | Example |
| 68 | 11 | 3 | 0.5 | 1.0 | 0.1 | 780 | ◯ | ◯ | Example |

The underline represents that the value is out of the scope of the present invention.

### INDUSTRIAL APPLICABILITY

The hot-dip coated steel sheet of the present disclosure is exceptional in formability and external appearance, and suppressed in formation of SiO₂ oxide, and thus has high industrial applicability.

1. A hot-dip coated steel sheet, comprising
a steel sheet, and
a coated layer provided on the steel sheet,
wherein
a first chemical composition that is a chemical composition of the steel sheet contains, by mass %,
C: 0.05%-0.20%,
Mn: 1.00%-3.00%,
Si: 0.40%-2.00%,
P: 0.001%-0.100%,
S: 0.0001%-0.0100%, and
Al: 0.001%-1.500%,
a balance includes Fe and impurities,
a tensile strength of the steel sheet is 740 MPa or more, and
in a region from a surface of the steel sheet up to 3 μm in a sheet thickness direction,
an area fraction of SiO₂ is less than 0.4%, and
a second chemical composition that is a chemical composition of the coated layer contains, by mass %,
Al: 10%-13%,
Mg: 3%-5%, and
Si: 0.5% or less,
a balance includes Zn and impurities,
the coated layer includes an Al—Fe-based interface alloy layer in contact with the surface of the steel sheet, and
a thickness of the Al—Fe-based interface alloy layer is 1.0-3.0 μm.

2. The hot-dip coated steel sheet according to claim 1, wherein the first chemical composition further contains, by mass %, one or more of
Ti: 0.001%-0.150%,
Nb: 0.001%-0.100%, and
V: 0.001%-0.300%.

3. The hot-dip coated steel sheet according to claim 1, wherein the first chemical composition further contains, by mass %, one or more of
Cr: 0.01%-2.00%,
Ni: 0.01%-2.00%,
Cu: 0.01%-2.00%,
Mo: 0.01%-2.00%,
B: 0.0001%-0.0100%, and
W: 0.01%-2.00%.

4. The hot-dip coated steel sheet according to claim 1, wherein the area fraction of SiO₂ is 0.1% or more.

5. The hot-dip coated steel sheet according to claim 1, wherein the first chemical composition further contains, by mass %,
one or more of Ca, Mg, Zr, and REM in a total amount of 0.0001%-0.0100%.

6. Method for manufacturing a hot-dip coated steel sheet, comprising a continuous coating step of coating a base steel sheet having a first chemical composition using a continuous hot-dip galvanizing line with all-radiant tube heating system, wherein
in the continuous coating step,
reduction annealing is performed on the base steel sheet in an atmosphere of 2-10 vol % of hydrogen and 0.002 vol %-0.05 vol % of water vapor under a reduction condition of a maximum temperature of a surface temperature of the base steel sheet of 775° C. or more and a retention time at 750° C. or more of 30 seconds or more,
the base steel sheet after the reduction annealing is immersed in a coating bath at
a coating bath temperature of 470° C.-520° C. and an entry material temperature of 470° C.-520° C., or
a coating bath temperature of 450° C. to less than 470° C. and an entry material temperature of 490° C.-520° C.
for 3 seconds or more,
the first chemical composition contains, by mass %,
C: 0.05%-0.20%,
Mn: 1.00%-3.00%,
Si: 0.40%-2.00%,
P: 0.001%-0.100%,
S: 0.0001%-0.0100%, and
Al: 0.001%-1.500%,
a balance includes Fe and impurities,
a chemical composition of the coating bath contains, by mass %,
Al: 10%-13%,
Mg: 3%-5%, and
Si: 0.5% or less, and
a balance includes Zn and impurities.

7. A frame obtained using the hot-dip coated steel sheet according to claim 1.
